(19) United States
(12) Patent Application Publication
(10) Pub. No.: US 2010/0222487 A1
(43) Pub. Date: Sep. 2, 2010

(54) INORGANIC HOLLOW POWDER, PROCESS FOR PRODUCING THE INORGANIC HOLLOW POWDER, AND COMPOSITION COMPRISING THE INORGANIC HOLLOW POWDER

(75) Inventors: Yasuhisa Nishi, Fukuoka (JP); Hiroaki Yoshigai, Fukuoka (JP); Mitsuyoshi Iwasa, Fukuoka (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Denki Kagaku Kogyo Kabushiki Kaisha, Chuo-ku, TOKYO (JP)

(21) Appl. No.: 12/063,087

(22) PCT Filed: Mar. 8, 2007
(86) PCT No.: PCT/JP2007/054508

§ 371 Date: Feb. 6, 2008

(30) Foreign Application Priority Data
Mar. 8, 2006 (JP) 2006-062622

(51) Int. Cl. C08K 3/36; C04B 35/14; C03B 19/10

(52) U.S. Cl. 524/493; 428/402; 65/21.4

(57) ABSTRACT

Inorganic hollow powder is provided having a high purity, an enhanced fineness and a high hollowness. Specifically, inorganic hollow powder is provided having an average particle diameter of 1 to 5 μm, the maximum particle diameter of 20 μm or less, a particle size distribution standard deviation of 3 μm or less, and an average hollowness of 35 to 70 vol %. The inorganic hollow powder is obtained, for instance, by supplying, via an inorganic feed material powder supply pipe at a discharge rate of 80 m/s or more, inorganic raw material powder having a specific surface area of 500 m²/g or more and an average particle diameter of 7 μm or less, into a flame formed by a burner comprising at least a triple pipe portion sequentially arranged with, in order from outside, a combustion supporting gas supply pipe, a combustible gas supply pipe and the inorganic feed material powder supply pipe. The present inorganic hollow powder is useful when blended in rubber and/or resin, for instance, for lowering the dielectric constant in multilayer printed boards, wiring covering materials, semiconductor encapsulating materials and the like.

### TECHNICAL FIELD

The present invention relates to inorganic hollow powder, a method for manufacturing the same, and a composition containing the same.

### BACKGROUND ART

Typical inorganic hollow powder includes hollow glass spherical powder. Hollow glass spherical powder has a lighter specific mass and better low-dielectric property, heat resistance, heat insulation property, pressure resistance and impact resistance than non-hollow inorganic powder, and also has a physical property-improving function such as electric characteristics, dimensional stability, moldability and the like. For these reasons, hollow glass spherical powder is used in molded articles such as molding compounds or the like in, for instance, automobiles, portable electronic articles, electric home appliances, as well as in putties, sealing materials, marine buoyant materials, artificial timber, reinforced cement outer-wall materials, lightweight outer-wall materials, imitation marble and the like. On the other hand, the hollow glass spherical powder functions to reduce dielectric property due to its spherical particle form. Therefore, the hollow glass spherical powder is expected to be used in fields where lower dielectric constant is required, for instance in multilayer printed boards, wire covering materials, semiconductor sealing materials and the like. Microscopic hollow glass spherical powder has thus a wide range of applications, but in recent years there has been strong demand for yet finer hollow glass spherical powder and for non-glass inorganic oxide hollow powder.

As an example of a method for manufacturing hollow glass spherical powder, JP-B 04-37017 discloses a method in which a glass-forming agent and a blowing agent are supported on silica gel powder and then calcined to yield powder having a particle density of in the order of 0.3 g/cm³ and an average particle diameter of about 70 μm. However, this manufacturing method causes the blowing agent to remain in the powder, which prevents achieving high purity, while making difficult to produce finer powder and higher degree of hollow structure (or hollowness).

### DISCLOSURE OF THE INVENTION

### Subject to be Attained by the Invention

It is an object of the present invention to provide inorganic hollow powder having a high purity, an enhanced fineness and a high hollowness, as well as a method of manufacturing the inorganic hollow powder, and a composition comprising the inorganic hollow powder in at least either of rubber or resin.

The present invention relates to inorganic hollow powder, having an average particle diameter of 1 to 5 μm, the maximum particle diameter of 20 μm or less, a particle size distribution standard deviation of 3 μm or less, and an average hollowness of 35 to 70 vol %. Preferably, the present invention provides at least one embodiment selected from the embodiments wherein the inorganic hollow powder has an average particle diameter/mode (relative maximum) particle diameter ratio of 0.75 to 1.25, wherein the inorganic hollow powder is amorphous silica hollow powder, and wherein the inorganic hollow powder is treated with a surface treating agent.

Also, the present invention relates to a method for manufacturing inorganic hollow powder, comprising supplying, via an inorganic raw material powder supply pipe at a discharge rate of 80 m/s or more, inorganic feed material powder having a specific surface area of 500 m²/g or more and an average particle diameter of 7 μm or less, into a flame formed by a burner comprising at least a triple pipe portion sequentially arranged with, in order from outside, a combustion supporting gas supply pipe, a combustible gas supply pipe and the inorganic raw material powder supply pipe, to yield inorganic hollow powder, followed by classifying thereof, if necessary. Amorphous silica powder having the above characteristics can be manufactured herein if the inorganic feed material powder is silica powder having a specific surface area of 700 m²/g or more.

The present invention relates also to a composition comprising the inorganic hollow powder of the present invention in at least either rubber or resin.

### EFFECT OF THE INVENTION

The present invention provides thus inorganic hollow powder having a high purity, an enhanced fineness and a high hollowness. For instance, the present invention provides inorganic hollow powder, for example amorphous spherical silica hollow powder, having a purity of 99 mass %, an average particle diameter of 3.1 to 4.7 μm, a hollowness from 53 to 66 vol %, and an average sphericity of 0.85 or more. As a result, a composition containing a suitable amount of such inorganic hollow powder, and having a good moldability, with a varnish viscosity of 800 mPa·s or less, in particular 700 mPa·s or less, allows thus manufacturing easily a rubber molded product or a resin molded product having a thermal expansion rate of 30 ppm or less, in particular 20 ppm or less, a V-0 flame retardancy, and a relative permittivity of 3.0 or less, in particular 2.8 or less (25° C., 1 GHz). In this case, the thermal expansion coefficient is given by the formula below.

(Dimensions after expansion−dimension before expansion)/(dimension before expansion)

### BEST MODE FOR CARRYING OUT THE INVENTION

The inorganic hollow powder of the present invention has an average particle diameter ranging from 1 to 5 μm, preferably from 3.1 to 4.7 μm, and the maximum particle diameter of 20 μm or less, preferably of 15 μm or less. When the average particle diameter exceeds 5 μm or the maximum particle diameter exceeds 20 μm, the surface smoothness of the rubber molded product or the resin molded product deteriorates, which may impair external aspect and/or give rise to surface irregularities. In addition, when it is used as interlayer insulating layer material or resist material filler in multilayer substrates, the inorganic hollow powder may fail to fit within a predetermined layer thickness, thus giving rise to problems such as shorts in conductive portions. From the viewpoint of, for instance, filling ability and miscibility with rubbers or resins, and handleability as powder, the lower limit of the average particle diameter must be set at 1 μm or more, preferably 3 μm or more.

The standard deviation of the particle size distribution of the inorganic hollow powder according to the present invention is 3 μm or less, preferably 2.5 μm or less. To date, no inorganic hollow powder has had a particle size distribution sharpness so rigorously controlled. A standard deviation in excess of 3 μm reduces the number of particles having a particle diameter in the vicinity of the average particle diameter, which makes it very difficult to achieve lighter weight and/or lower permittivities.

Preferably, inorganic hollow powder having the above standard deviation exhibits an average particle diameter/mode particle diameter ratio of 0.75 to 1.25. When this ratio is considerably smaller than 0.75, there would exist numerous small particles in the inorganic hollow powder, so that the hollowness decreases, and moldability of the rubber or resin would be impaired if the inorganic hollow powder content thereof is high. On the other hand, when the ratio is markedly larger than 1.25, there would exist numerous coarse particles in the inorganic hollow powder, which, although hollowness may be increased, lowers the particle strength and which may result in particle breakage during powder handling and/or during particle kneading in rubber or resin. Much preferably, the average particle diameter/mode particle diameter ratio ranges from 0.80 to 1.20.

Preferably, the average sphericity of the inorganic hollow powder is 0.80 or more, in particular 0.85 or more. This allows enhancing its filling ability into rubber or resin and further enhancing the moldability of the resultant composition.

The material of the inorganic hollow powder is not particularly limited, and may include, for instance, silica, alumina, zirconia, titania, magnesia and the like, as well as a complex oxide having as a constituent component at least one of the foregoing components. Amongst them, amorphous silica is preferred in respect of its excellent strength, low thermal expansion, and electric insulation characteristics. Preferably, the purity thereof is 98 mass % or more. In case of a complex oxide having two or more components, the components that make up the complex oxide are not considered as impurities.

The average particle diameter, the maximum particle diameter, mode particle diameter and standard deviation of the inorganic hollow powder can be determined by measuring the particle size distribution of the inorganic hollow powder by laser diffraction scattering. The particle size distribution is measured in a range from 0.04 to 2000 μm, in 116 fractions having a log(μm) width=0.04. The measuring instrument may be, for instance, a “model LS-230” by Beckman Coulter Inc. The measurement is carried out after mixing the sample with water, followed by dispersion over 1 minute using an ultrasonic homogenizer at 200 W output. The PIDS (polarization intensity differential scattering) concentration is adjusted to 45 to 55 mass %. The refractive index used for water is 1.33, while the refractive index used for the sample is the refractive index of the material thereof, for instance 1.50 in case of amorphous silica.

A mode particle diameter is taken as the central value in the particle range that exhibits an extremal in a frequency particle size distribution. The frequency particle size distribution is a particle size distribution expressed as a histogram in which the particle diameter range is divided, with mass % units corresponding to the masses of the particles in the respective particle diameter divisions. For instance, in a cumulative particle size distribution where the cumulative value up to 3.2 μm is 50 mass %, the cumulative value up to 3.6 μm is 65 mass %, the cumulative value up to 4.0 μm is 70 mass %, and the particle range from 3.2 to 3.6 μm exhibits an extremal, the frequency value is then calculated as 15% and the mode diameter 3.4 μm is calculated as the central value between 3.2 μm and 3.6 μm.

Average sphericity is measured as follows. Particle images obtained using, for example, a microscope (for instance, “model SMZ-10” by Nikon) are loaded into an image analyzer (for instance, “Mac View” by Mountain Tech), to measure the projected area (A) and the perimeter (PM) of the photographed particles. The circularity of the particles is A/B, wherein (B) is the circular area corresponding to the perimeter (PM). Accordingly, a hypothetical circle having a perimeter identical to the perimeter (PM) of the sample would exhibit PM=2πr, B=πr², and hence B=π×(PM/2π)², so that the sphericity of the respective particles is sphericity=A/B=A×4π/(PM)². The average sphericity is the average value of the sphericities thus determined for 200 arbitrary particles.

Amorphousness is measured by X-ray diffraction, on the basis of the intensity ratio of specific diffraction peaks, using a powder X-ray diffractometer (for instance, “model Mini Flex” by RIGAKU) with a 2θ range of 26° to 27.5° for CuKα rays. In case of silica powder, for instance, crystalline silica exhibits a main peak at 26.7°, while amorphous silica exhibits no peak. When amorphous silica is mixed with crystalline silica, the resultant height of the 26.7° peak varies in accordance with the proportion of crystalline silica. The mixing ratio of crystalline silica (X-ray diffraction intensity of sample/X-ray diffraction intensity of crystalline silica) is thus calculated based on the ratio of X-ray intensity of the sample relative to the X-ray intensity of a crystalline silica standard sample. Amorphousness is then obtained using the formula: amorphousness (%)=(1-crystalline silica mixing ratio)×100.

The amount of impurities can be measured using, for instance, an X-ray fluorescence (XRF) spectrometer, an energy dispersive X-ray fluorescence (EDX) spectrometer, an atomic absorption (AAS) spectrometer, an inductively coupled plasma (ICP) atomic emission spectrometer or the like. The purity of silica powder can be measured by dissolving the powder, under heating, in a mixed solution of hydrofluoric acid and perchloric acid, followed by dilution with pure water, and measurement using, for instance, an atomic absorption spectrometer made by Shimadzu.

The average hollowness of inorganic hollow powder ranges from 35 to 70 volume % (vol %), preferably from 40 to 65 vol %. When the average hollowness is smaller than 35 vol %, the mass reduction, heat insulation and low permittivity functions are not manifested sufficiently, whereas beyond 70 vol %, the shell thickness of the particles becomes thin, which may result in particle breakage during powder handling and/or during particle kneading in rubber or resin.

Average hollowness is defined as the ratio between a measured value of particle density relative to the theoretical particle density value. For instance, a measured value of the density of silica hollow particles of 1.1 g/cm³ divided by 2.2 g/cm³, the theoretical density of amorphous silica, yields a calculated average hollowness of 50 vol %. Density is measured herein using an automatic pycnometric instrument for measuring the true density of particulates (for instance, “Auto True Denser MAT 7000” by Seishin).

The inorganic hollow powder is preferably treated using a surface treating agent, for instance a coupling agent or the like. The surface of inorganic powder is ordinarily hydrophilic and has poor dispersibility in hydrophobic dispersion media such as resins, organic solvents and the like. Performing a surface treatment allows hence improving dispersibility. A surface treatment is also effective for enhancing, for instance, adhesiveness towards rubbers or resins, peel strength, and moisture resistance reliability. The amount of surface treating agent used ranges preferably prom 0.05 to 2 parts by mass relative to 100 parts by mass of the inorganic hollow powder.

Surface treating agents that can be used include, for instance, silane coupling agents, Zr chelates, titanate coupling agents, aluminate-based coupling agents and the like. Silane coupling agents include, for instance, epoxysilanes such as γ-glycidoxypropyltrimethoxysilane and β-(3,4-epoxy-cyclohexyl)ethyltrimethoxysilane, aminosilanes such as aminopropyltrimethoxysilane, ureidopropyltriethoxysilane, N-phenylaminopropyltrimethoxysilane, hydrophobic silane compounds such as phenyltrimethoxysilane, methyltrimethoxysilane, octadecyltrimethoxysilane and mercaptosilanes.

The inorganic hollow powder of the present invention can be manufactured, for instance, using the manufacturing method of the present invention. Methods for increasing and decreasing average particle diameter, the maximum particle diameter, mode particle diameter, average sphericity, amorphousness, standard deviation and average hollowness in the manufacturing method of the present invention are described below.

In the manufacturing method of the present invention, hollowing is difficult to increase when the specific surface area of the inorganic feed material powder is less than 500 m²/g, or when the average particle diameter thereof exceeds 7 μm. Preferably, the specific surface area of the inorganic feed material powder is at 600 m²/g or more, in particular 700 m²/g or more, while the average particle diameter is preferably 2 to 5 μm. Preferably, the maximum particle diameter is 20 μm or less. When the discharge rate of the inorganic feed material powder is below 80 m/s, the inorganic feed material powder becomes overheated, the hollowed particles swell excessively, the particle diameter becomes coarser, and the particles may break, all of which hampers the manufacture of the sharp inorganic hollow powder of the present invention. The discharge rate is preferably 100 m/s or more, in particular 150 m/s or more. Preferably, the upper limit of the discharge rate is, for instance, 700 m/s.

Substances that can be used as the inorganic feed material powder include, for instance, silica, alumina, zirconia, titania, magnesia, calcia and the like, as well as a complex oxide having as a constituent component at least one of the foregoing components. Amongst them, silica gel powder having a specific surface area of 700 m²/g or more is preferably used as the inorganic feed material powder, in order to manufacture amorphous silica hollow powder having excellent electrical characteristics, chemical stability and moldability. Preferably, the upper limit of the specific surface area is, for instance, 1200 m²/g.

The inorganic feed material powder is supplied into a flame from an inorganic feed material powder supply pipe of a burner comprising at least a triple pipe portion in which there are sequentially arranged, in this order from outside, a combustion supporting gas supply pipe, a combustible gas supply pipe and the inorganic feed material powder supply pipe. The definition of such a burner comprising at least a triple pipe portion includes also a burner in which, adjacent to the triple pipe portion, there are arranged one or two or more pipes among a combustible gas supply pipe, a combustion supporting gas supply pipe, and an inorganic feed material powder supply pipe. The method for supplying the inorganic feed material powder may be a dry method in which the inorganic feed material powder is carried by at least one gas selected, for instance, from among air, nitrogen, oxygen, argon, helium, a combustible gas or the like, or a wet method in which the inorganic feed material powder is dispersed in at least one solvent selected, for instance, from among water, a combustible liquid, an organic solvent or the like, and is supplied in the form of a slurry. A dry method is preferred herein in terms of productivity.

The flame can be formed by injecting into a furnace respective gases from the combustion supporting gas supply pipe and the combustible gas supply pipe. Examples of the combustible gas include, for instance, hydrogen gas, hydrocarbon gases such as methane, ethane, acetylene, propane, butane, propylene and the like. Examples of the combustion supporting gas include, for instance, air, oxygen and the like.

The temperature of, for instance, a flame positioned at 10 cm in a below-described vertical furnace, ranges suitably from 1300 to 2000° C., preferably from 1400 to 1900° C.

The flame-forming furnace may be either a vertical furnace or a horizontal furnace. However, the vertical furnace, wherein the above described burner is arranged at the top of the furnace and the bottom of the furnace is connected to a trapping system, is preferred herein in view of suppressing adhesion of the inorganic hollow powder to the interior of the furnace, and also in terms of flame stability and operation stability. A dust collector is installed in the trapping system. In this case, the produced inorganic hollow powder is suctioned and conveyed, by means of a blower or the like provided at an exhaust side, together with, for instance, combustion exhaust gas or air actively supplied from the bottom of the furnace, so that the conveyed inorganic hollow powder is collected and also sorted, if necessary. As the dust collector, there may be used, for instance, a cyclone, an electrostatic dust collector, a bag filter or the like. Excluding the burner structure, numerous known furnace structures can be used in such a vertical furnace.

The average sphericity of the inorganic hollow powder can be adjusted and controlled by controlling the temperature inside the furnace, mainly by regulating the rate of flow of the combustible gas. The average particle diameter, largest particle diameter, the maximum particle diameter, standard deviation of the particle size distribution, and the average particle diameter/mode particle diameter ratio can be adjusted and controlled mainly through the granularity of the inorganic feed material powder and/or through the discharge rate of the inorganic feed material powder. Average hollowness can be adjusted and controlled by means of the specific surface area of the inorganic feed material powder and the discharge rate of the inorganic feed material powder. When the flow rate of the combustible gas is increased, specifically, the temperature inside the furnace increases, and the feed material is heated sufficiently, thereby affording an inorganic hollow powder of high average sphericity. If the flow rate of the combustible gas is excessive, and/or the discharge rate of the inorganic feed material powder into the flame is too slow, the powder overheats and the hollow powder swells excessively, while particle diameter becomes coarser, as a result of which the particles may break. The larger the specific surface area of the inorganic feed material powder, the likelier it is that air bubbles become trapped in the material during thermal spherification. This allows manufacturing a high-hollowness inorganic hollow powder.

The composition of the present invention is prepared by incorporating the inorganic hollow powder of the present invention into at least either rubber or resin. The content rate of the inorganic hollow powder is wholly free, and may range for instance from 1 to 97 mass %, preferably from 5 to 80 mass %.

Examples of the rubber include, for instance, natural rubber, polybutadiene rubber (BR), styrene-butadiene copolymer rubber (SBR), polyisoprene rubber (IR), nitrile-butadiene copolymer rubber (NBR), butyl rubber (IIR) and the like.

Examples of the resin include, for instance, epoxy resins, silicone resins, phenolic resins, melamine resins, urea resins, unsaturated polyester, fluoropolymer resins, BT resins, polyimides, polyamideimides, polyamides such as polyether amides, polyesters such as polybutylene terephthalate, polyethylene terephthalate, polyphenylene sulfide, wholly aromatic polyesters, polysulphones, liquid crystal polymers, polyether sulfones, polycarbonate, maleimide modified resins, ABS resins, AAS (acrylonitrile-acrylic rubber-styrene resins, AES (acrylonitrile/ethylene/propylene/diene rubber-styrene) resins and the like.

Among them, epoxy resin having two or more epoxy groups in a molecule is preferred as a material for multilayer printed board or as a material for semiconductor encapsulation. Concrete examples thereof include, for instance, phenolic novolac-type epoxy resins, ortho-cresol novolac-type epoxy resins, epoxy resins obtained by epoxidation of novolac resin from phenols and aldehydes, glycidyl ester epoxy resins obtained by reacting a glycidyl ester such as bisphenol A, bisphenol F or bisphenol S with a polybasic acid such as phthalic acid or maleic acid and epichlorohydrin, linear aliphatic epoxy resins, alicyclic epoxy resins, heterocyclic epoxy resins, alkyl modified polyfunctional epoxy resins, β-naphthol novolac-type epoxy resins, 1,6-dihydroxynaphthalene epoxy resins, 2,7-dihydroxynaphthalene epoxy resins, bishydroxybiphenyl epoxy resins, as well as epoxy resins in which a halogen such as bromine is introduced for imparting flame retardancy. In particular, ortho-cresol novolac-type epoxy resins, bishydroxybiphenyl epoxy resins and naphthalene-backbone epoxy resins are ideal from the viewpoint of moisture resistance and solder reflow resistance.

As the curing agent of the epoxy resin, there is used at least one agent selected from among novolac resins, polyparahydroxystyrene resins, phenols, anhydrides, aromatic amines and the like. As the novolac resin, there may be used a novolac resin obtained by reacting, in the presence of an acid catalyst, at least one phenol selected from among phenol, cresol, xylenol, resorcinol, chlorophenol, t-butyl phenol, nonyl phenol, isopropyl phenol, octyl phenol and the like, with at least one compound selected from among formaldehyde, paraformaldehyde, paraxylene and the like. As the phenol, there may be used a bisphenol compound such as bisphenol A, bisphenol S or the like, and/or a trifunctional phenol such as pyrogallol, phloroglucinol or the like. As the anhydride, there may be used maleic anhydride, phthalic anhydride, pyromellitic anhydride and the like. As the aromatic amine, there may be used metaphenylene diamine, diamino diphenyl methane, diamino diphenyl sulfone or the like.

When the composition of the present invention is an epoxy resin composition, a curing accelerator may be included in the formulation in order to promote the reaction between the epoxy resin and the epoxy resin curing agent. As the curing accelerator is used, for instance, one or more compounds selected from among 1,8-diazabicyclo[5.4.0]undecene-7, triphenylphosphine, benzyldimethylamine, 2-methyl imidazole and the like.

The composition of the present invention may also contain, as the case may require, a stress-reducing agent, a flame retardant auxiliary agent, a flame retardant, a coloring agent, a mold release agent and the like. As the stress-reducing agent, there may be used, for instance, a rubbery substance such as silicone rubber, polysulfide rubber, acrylic rubber, butadiene rubber, styrene block copolymers, saturated elastomers and the like, and a modified epoxy resin modified with an amino silicone, epoxy silicone, alkoxy silicone or the like, or a modified phenolic resin. As the flame retardant auxiliary agent, there may be used, for instance, Sb₂O₃, Sb₂O₄, Sb₂O₅ or the like; as the flame retardant, there may be used a halogenated epoxy resin or a phosphorus compound; and as the coloring agent, there may be used carbon black, iron oxide, a dye, a pigment or the like. As the mold release agent, there may be used, for instance, natural wax, a synthetic wax, a metal salt of a straight-chain fatty acid, an acid amide, or an ester and wax.

Adding an ion-trapping agent is effective in applications that require moisture resistance stability and high-temperature storage stability. Examples of ion-trapping agents include, for instance, “DHF-4A”, “KW-2000” and “KW-2100”, by Kyowa Chemical Industry, or “IXE-600” by Toagosei Chemical Industry.

The composition of the present invention can be manufactured, for instance, by blending predetermined amounts of the above materials using a blender, a Henschel mixer or the like, kneading the resulting blend using a heated roll, a kneader, a uniaxial or biaxial extruder or the like, and cooling the kneaded product, followed by crushing thereof. In multilayer printed board applications or coating applications, the above materials are mixed with an organic solvent to yield a varnish, using a mixing equipment such as a grinding machine, a bead mill, a three-roll mill, a stirring mixer or the like. After preparation of the varnish, air bubbles in the varnish are preferably removed by vacuum deaeration. Adding a defoaming agent such as silicone or an acrylic or fluorine-based defoaming agent is effective for imparting the varnish with defoaming ability and foam-breaking ability.

### EXAMPLES

The apparatus used in the examples was a furnace having arranged at the top thereof three burners comprising each a triple-pipe structure nozzle in which there were sequentially arranged, in this order from outside, a combustion supporting gas supply pipe, a combustible gas supply pipe and an inorganic feed material powder supply pipe, with the bottom of the furnace being connected to a collecting system (cyclone, bag filter). The resultant inorganic hollow powder, together with exhaust gas, was suction-conveyed by a blower and was collected in the cyclone and bag filter.

### Examples 1 to 7, Comparative Examples 1 to 4

Through each burner there were supplied 3 to 5 Nm³/Hr of LPG through the combustible gas supply pipe, and 3 to 5 Nm³/Hr of oxygen through the combustion supporting gas supply pipe to form a flame (temperature at a position 10 cm from the tip of the burner: 1500 to 1800° C.). At the same time, about 3 kg/Hr of the inorganic feed material powders (silica gel powder) listed in Table 1, carried in 10 to 40 Nm³/Hr of conveying air, were supplied through the inorganic feed material powder supply pipe into the middle of the flame. The discharge rates of the inorganic feed material powder were as given in Table 1. In the cyclone there was collected inorganic hollow powder (spherical silica hollow powder) the characteristics of which varied depending on the differences in the amounts of supplied LPG and oxygen, and on the discharge rate of the inorganic feed material powder. The granularity (average particle diameter D50, maximum particle diameter D100, standard deviation, average particle diameter/mode particle diameter ratio), average hollowness, purity and average sphericity of the inorganic hollow powder were measured as described above. The results are given in Table 1. For a surface treatment with a silane coupling agent there were used 0.5 parts by mass of vinyl silane relative to 100 parts by mass of the inorganic hollow powder. The treatment was carried out for 10 minutes using a Henschel mixer for mixing.

To evaluate the characteristics of the obtained inorganic hollow powders, 100 parts by mass of a brominated bisphenol A-type epoxy resin, 4 parts by mass of dicyandiamide and 0.2 parts by mass of 2-ethyl 4-methyl imidazole were dissolved in 200 parts by mass of methyl ethyl ketone. To the solution were then added 1 part by mass of 3-glycidoxypropyltrimethoxysilane and 100 parts by volume of the inorganic hollow powder relative to 100 parts by volume of the above epoxy resin, followed by stirring for 10 minutes in a high-speed mixer, to prepare a varnish.

After measuring the viscosity of the obtained varnish, a glass cloth was impregnated with the varnish and was dried for 5 minutes in an electric oven at 150° C., after which the glass cloth was cut to yield a prepreg. A laminate was manufactured by stacking 12 sheets of this prepreg and by pressing the sheets in a heated press for 150 minutes under a pressure of 4.5 MPa and a temperature of 185° C., then the thermal expansion rate, the flame retardancy and the relative permittivity of the laminate were measured. The results are given in Table 1.

(1) Varnish viscosity: Viscosity was measured using an E-type viscometer by Tokimec Co. Measurement conditions: 3°R14 cone rotor, temperature 30° C., rotor revolutions 2.5 rpm.

(2) Thermal expansion rate of the laminate: Test pieces having a diameter of 5 mm and a height of 10 mm were cut from the laminate, and were measured using a thermomechanical analyzer (TMA) by Shimadzu, in accordance with JIS K7197.

(3) Flame retardancy of the laminate: 12.7 mm×127 mm×1 mm test pieces were cut from the laminate and were measured in accordance with UL-94.

(4) Relative permittivity of the laminate: Test pieces having a diameter of 100 mm and a thickness of 2 mm were cut from the laminate and were measured in accordance with JIS K6911 using a permittivity measuring instrument by Hewlett Packard.

TABLE 1

| | | Example 1 | Example 2 | Example 3 | Example 4 | Example 5 |
|---|---|---|---|---|---|---|
| Inorganic feed material | Specific surface area | 715 | 715 | 589 | 767 | 549 |
| powder | (m²/g) | | | | | |
| | Average particle diameter | 3.7 | 3.7 | 5.1 | 4.4 | 3.6 |
| | (μm) | | | | | |
| | Oxide concentration other | 0.2 | 0.2 | 0.2 | 0.3 | 0.2 |
| | than SiO₂ | | | | | |
| | (%) | | | | | |
| Inorganic feed material | | 80 | 150 | 100 | 100 | 150 |
| powder discharge rate | | | | | | |
| (m/s) | | | | | | |
| Spherical inorganic | Average particle diameter | 3.1 | 3.0 | 4.7 | 4.5 | 2.1 |
| hollow powder | (μm) | | | | | |
| | Maximum particle diameter | 15 | 10 | 18 | 18 | 15 |
| | (μm) | | | | | |
| | Standard deviation | 1.8 | 1.6 | 1.6 | 1.4 | 2.6 |
| | (μm) | | | | | |
| | Average hollowness | 59 | 64 | 53 | 66 | 60 |
| | (vol %) | | | | | |
| | Mode particle diameter | 3.6 | 3.7 | 4.3 | 4.7 | 2.9 |
| | (μm) | | | | | |
| | Average particle diameter/ | 0.86 | 0.81 | 1.09 | 0.96 | 0.72 |
| | Mode particle diameter | | | | | |
| | (—) | | | | | |
| | Average sphericity | 0.90 | 0.89 | 0.88 | 0.91 | 0.92 |
| | (—) | | | | | |
| | Surface treatment | Yes | Yes | Yes | Yes | Yes |
| | Oxide concentration other | 0.2 | 0.2 | 0.1 | 0.3 | 0.1 |
| | than SiO₂ | | | | | |
| | (%) | | | | | |
| Laminate | Varnish viscosity | 630 | 560 | 530 | 760 | 640 |
| | (mPa · s) | | | | | |
| | Thermal expansion rate | 15 | 16 | 13 | 15 | 18 |
| | (ppm) | | | | | |
| | Flame retardancy | V-0 | V-0 | V-0 | V-0 | V-0 |
| | (UL-94, | | | | | |
| | vertical test) | | | | | |
| | Relative permittivity | 2.7 | 2.7 | 2.8 | 2.6 | 2.9 |
| | (—) | | | | | |
| | 25° C., | | | | | |
| | 1 GHz | | | | | |

| | | | | Comparative | Comparative | Comparative | Comparative |
|---|---|---|---|---|---|---|---|
| | | Example 6 | Example 7 | example 1 | example 2 | example 3 | example 4 |
| Inorganic | Specific surface | 765 | 765 | 594 | 654 | 368 | 623 |
| feed | area | | | | | | |
| material | (m²/g) | | | | | | |
| powder | Average particle | 3.2 | 3.2 | 8.3 | 4.5 | 3.9 | 5.6 |
| | diameter | | | | | | |
| | (μm) | | | | | | |
| | Oxide | 2.1 | 2.1 | 0.3 | 7.7 | 0.3 | 0.2 |
| | concentration | | | | | | |
| | other than SiO₂ | | | | | | |
| | (%) | | | | | | |
| Inorganic | | 100 | 100 | 100 | 60 | 80 | 40 |
| feed | | | | | | | |
| material | | | | | | | |
| powder | | | | | | | |
| discharge | | | | | | | |
| rate | | | | | | | |
| (m/s) | | | | | | | |
| Spherical | Average particle | 3.1 | 3.1 | 7.5 | 4.4 | 3.8 | 5.0 |
| inorganic | diameter | | | | | | |
| hollow | (μm) | | | | | | |
| powder | Maximum particle | 18 | 18 | 20 | 32 | 18 | 20 |
| | diameter | | | | | | |
| | (μm) | | | | | | |
| | Standard deviation | 2.4 | 2.4 | 2.3 | 1.5 | 2.1 | 3.2 |
| | (μm) | | | | | | |
| | Average hollowness | 63 | 63 | 65 | 49 | 25 | 54 |
| | (vol %) | | | | | | |
| | Mode particle | 2.4 | 2.4 | 7.3 | 4.6 | 4.1 | 6.8 |
| | diameter | | | | | | |
| | (μm) | | | | | | |
| | Average particle | 1.27 | 1.27 | 1.03 | 0.96 | 0.93 | 0.74 |
| | diameter/ | | | | | | |
| | Mode particle | | | | | | |
| | diameter | | | | | | |
| | (—) | | | | | | |
| | Average sphericity | 0.89 | 0.89 | 0.86 | 0.90 | 0.91 | 0.88 |
| | (—) | | | | | | |
| | Surface treatment | Yes | No | Yes | Yes | Yes | No |
| | Oxide | 2.1 | 2.1 | 0.3 | 7.6 | 0.2 | 0.2 |
| | concentration | | | | | | |
| | other than SiO₂ | | | | | | |
| | (%) | | | | | | |
| Laminate | Varnish viscosity | 660 | 950 | 1540 | 790 | 740 | 980 |
| | (mPa · s) | | | | | | |
| | Thermal expansion | 19 | 19 | 19 | 56 | 18 | 17 |
| | rate | | | | | | |
| | (ppm) | | | | | | |
| | Flame retardancy | V-0 | V-0 | V-0 | V-0 | V-0 | V-0 |
| | (UL-94, | | | | | | |
| | vertical test) | | | | | | |
| | Relative | 2.8 | 2.9 | 3.8 | 3.8 | 3.4 | 3.6 |
| | permittivity | | | | | | |
| | (—) | | | | | | |
| | 25° C., | | | | | | |
| | 1 GHz | | | | | | |

A comparison between the examples and the comparative examples shows that the examples of the present invention there were able to manufacture a laminate, as well as an inorganic hollow powder used therein. Specifically, the present vanish containing the present inorganic hollow powder had a good moldability, a varnish viscosity of 800 mPa·s or less, in particular 700 mPa·s or less, and a thermal expansion rate of 30 ppm or less, in particular 20 ppm or less, and the resultant product had a V-0 flame retardancy and a relative permittivity of 3.0 or less, in particular 2.8 or less.

### INDUSTRIAL APPLICABILITY

The inorganic hollow powder of the present invention is used for a resin molding product such as a molding compound or the like in, for instance, automobiles, portable electronic devices, electric home appliances, and also as a filler in, for instance, putties, sealing materials, marine buoyant materials, artificial timber, reinforced cement outer-wall materials, lightweight outer-wall materials and the like. The composition of the present invention is impregnated on a glass cloth, a glass nonwoven cloth or another organic substrate, and is cured to yield a prepreg for printed boards, or to yield an electronic component through heating and molding of one or more sheets of such a prepreg together with copper foil and the like. The composition of the present invention is also is used in the manufacture of a varnish, a wiring covering material, a semiconductor encapsulating material or the like.

1. Inorganic hollow powder, having an average particle diameter of 1 to 5 μm, the maximum particle diameter of 20 μm or less, a particle size distribution standard deviation of 3 μm or less, and an average hollowness of 35 to 70vol %.

2. The inorganic hollow powder of claim 1, further having an average particle diameter to mode particle diameter ratio is 0.75 to 1.25.

3. The inorganic hollow powder of claim 1 or 2, being amorphous silica hollow powder.

4. The inorganic hollow powder of any of claims 1 to 3, being treated with a surface treating agent.

5. A method for manufacturing inorganic hollow powder, characterized by supplying, via an inorganic feed material powder supply pipe at a discharge rate of 80 m/s or more, inorganic feed material powder having a specific surface area of 500 m²/g or more and an average particle diameter of 7 μm or less, into a flame formed by a burner comprising at least a triple pipe portion sequentially arranged with, in order from outside, a combustion supporting gas supply pipe, a combustible gas supply pipe and the inorganic feed material powder supply pipe, to yield inorganic hollow powder, followed by classifying thereof, if necessary.

6. A composition comprising the inorganic hollow powder of any of claims 1 to 4 in at least either rubber or resin.
